(19) United States
(12) Patent Application Publication
(10) Pub. No.: US 2026/0211936 A1
(43) Pub. Date: Jul. 23, 2026

(54) VERIFICATION OF CONTEXT DATA FOR INFERENCING

(71) Applicant: Dell Products L.P., Round Rock, TX (US)

(72) Inventors: OFIR EZRIELEV, Be'er Sheva (IL); LEV MAKLER, Be'er Sheva (IL); YEHONATAN COHEN, Ashdod (IL)

(21) Appl. No.: 19/034,846

(22) Filed: Jan. 23, 2025

(51) Int. Cl. G06F 16/36

(52) U.S. Cl. CPC G06F 16/367; G06F 16/33; G06F 40/00

(57) ABSTRACT

Methods and systems for managing operation of a data processing system are disclosed. A retrieval process for a prompt may be performed to obtain chunks of context data. The chunks of the context data may be tagged as related to at least a portion of ontology terms identified as present in the prompt. Combinations of the chunks may be obtained based on representations of the chunks to identify a combination of the chunks that is related to an ontology term specified by the ontology definitions. The combination of the chunks may be processed to obtain modifications for use of the context data. A response may be obtained from a trained generative machine-learning model using the prompt, the context data, and the modifications. The response may be used to provision desired computer-implemented services.

### FIELD

Embodiments disclosed herein relate generally to managing data processing systems. More particularly, embodiments disclosed herein relate to systems and methods to manage operation of the data processing systems using inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with an embodiment.

FIGS. 2A-2C show data flow diagrams in accordance with an embodiment.

FIGS. 3A-3B show flow diagrams illustrating methods in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of data processing systems that may provide computer-implemented services. The computer-implemented services may be provided using inference models (e.g., artificial intelligence models). The inference models may be used to generate inferences regarding operation of the data processing systems, and the inferences may be used in downstream processes to increase a likelihood of desired operation of the data processing systems. For example, the inference models may be trained to infer information regarding occurrences of security events (e.g., security threats) to the data processing systems based on ingest data, and the operation of the data processing systems may be updated to mitigate and/or prevent negative outcomes associated with the security events.

However, a quality (e.g., reliability) of the inferences used to manage the operation of the data processing systems may depend on a quality (e.g., of information content) of the ingest data provided to the (trained) inference models to obtain the inferences. For example, the ingest data may include a prompt based on input from a downstream consumer of the inferences. If the information content of the prompt is limited and/or ambiguous, then the ingest data to the inference model may be inadequate for generating an inference of expected quality.

To increase a likelihood of generating an inference of expected quality, a retrieval-augmented generation process may be implemented. During the retrieval-augmented generation process, context data (e.g., additional information regarding terms such as words and/or phrases in the prompt) may be retrieved from a trusted knowledge base during a retrieval process. The context data may then be used to increase the information content of the ingest data provided to the inference models to generate the inference.

However, due to limitations of the retrieval process, the context data may not be appropriate for generating expected quality ingest data (e.g., ingest data with adequate information content). For example, (i) meaningful terms present in the prompt for which additional context is required may not be identified, (ii) sufficient context data may not be obtained for each identified term in the prompt, and/or (iii) the context data may include hidden information associated with the identified terms. For example, the hidden information may include negative information content (e.g., irrelevant, out of date, and/or incorrect information) describing a term that, if processed by the inference model, my reduce a quality of inferences generated using the inference model.

Thus, to increase a likelihood of providing expected quality ingest data to the inference models, (i) the retrieval process may be performed (e.g., iteratively) to retrieve context data until sufficiency criteria for the context data is met, and (ii) verification processes may be performed to identify and manage hidden information included in retrieved context data.

To do so, an ontology for use of the inference models may be defined. The ontology may include ontology definitions that specify a list of ontology terms (e.g., words and/or phrases) that have been designated as having a higher degree of meaning by an operator of the inference models than degrees of meaning of other terms. Each instance of an ontology term present in the prompt may be identified, retrieval processes may be performed to retrieve context data for each instance of the ontology terms, and verification processes may be performed to identify combinations of chunks of the context data that may include hidden information associated with the ontology terms. Modifications for use of the context data (e.g., instructions for managing the identified hidden information) may be obtained, and the context data may be analyzed with respect to the sufficiency criteria using the modifications.

By doing so, context data obtained during retrieval processes may be more likely to be sufficient for improving a quality of the ingest data to the inference models, thereby improving a quality of the inferences used to manage operation of the data processing systems.

In an embodiment, a method for managing operation of a data processing system is provided. The method may include: performing a retrieval process for a prompt to obtain chunks of context data, wherein instances of a portion of ontology terms specified by ontology definitions are identified as present in the prompt, and the chunks of the context data are tagged as related to at least a portion of the identified ontology terms; obtaining combinations of the chunks based on representations of the chunks to identify a combination of the chunks that is related to an ontology term specified by the ontology definitions; processing the combination of the chunks based, in part, on the ontology term to obtain modifications for use of the context data; obtaining a response from a trained generative machine-learning model using the prompt, the context data, and the modifications; and, using the response to provision desired computer-implemented services.

The prompt may be a submission to be processed by the trained generative machine-learning model to facilitate provisioning of the desired computer-implemented services.

Obtaining the combinations of the chunks may include: obtaining a first representation for the combination of the chunks; comparing the first representation to a second representation of the ontology term to identify a level of similarity between the first representation and the second representation; and, treating the combination of the chunks as related to the ontology term based on the level of similarity and a similarity threshold. The first representation and the second representation may include multi-dimensional vectors indicating characteristics of words and/or phrases.

Processing the combination of the chunks may include treating the combination of the chunks as tagged as being related to the ontology term. Processing the combination of the chunks may include adding an indication to the modifications to mitigate a negative information content impact on the response due to the combination of the chunks.

Performing the retrieval process may include performing a first retrieval process for the prompt to obtain first context data of the context data.

Obtaining the response may include: making, using the modifications, a determination regarding whether the context data meets sufficiency criteria, the sufficiency criteria specifying a minimum level of content of the context data with respect to the portion of the ontology terms; and, in a first instance of the determination where the context data does not meet the sufficiency criteria: identifying, using the modifications, at least one instance of an ontology term of the ontology definitions in the prompt for which the context data does not meet the sufficiency criteria, and performing a second retrieval process for the prompt using a revised query that is based on at least the ontology term to obtain second context data of the context data.

The ontology definitions may include a list of ontology terms including the identified ontology terms, and the ontology terms specified by the ontology definitions may be words and/or phrases that have been designated as having a higher degree of meaning by an operator of the trained generative machine-learning model than other words and/or phrases not designated as having the higher degree of meaning by the operator.

The context data may be obtained from a data source designated as a source of true data by the operator of the trained generative machine-learning model, and the data source may include a number of chunks of data that are each tagged to associate each of the number of chunks of data with the ontology terms.

Using the response to provision the desired computer-implemented services may include updating the operation of the data processing system.

A non-transitory media may include instructions that when executed by a processor cause the computer-implemented method to be performed.

A system may include the non-transitory media and a processor, and may perform the computer-implemented method when the computer instructions are executed by the processor.

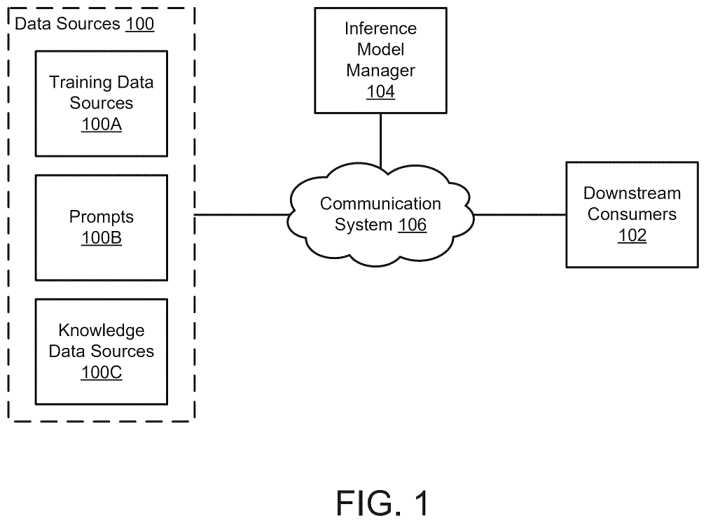

Turning to FIG. 1, a block diagram illustrating a distributed system in accordance with an embodiment is shown. The system shown in FIG. 1 may provide computer-implemented services. The computer-implemented services may include any type and quantity of computer-implemented services. For example, the computer-implemented services may include communication services, data storage services, database services, data generation services, and/or any other type of service that may be implemented with a computing device.

The computer-implemented services may be provided by data processing systems to consumers of the computer-implemented services (e.g., users of the data processing systems, other data processing systems). To provide the computer-implemented services, operation of the data processing systems may be managed, for example, in accordance with policies (e.g., security policies, acceptable use policies). The policies may be enforced via updates to the operation of the data processing system over time to increase a likelihood of providing desired (e.g., secure, reliable) computer-implemented services.

The operation of the data processing system may be managed using artificial intelligence. For example, (trained) inference models may be used to assess, predict, and/or otherwise manage occurrences of events that may negatively impact provisioning of the computer-implemented services as desired, such as security events that may threaten the security of the data processing system (e.g., sensitive data accessible using the data processing systems).

To do so, an inference model such as a generative machine-learning model may be trained to generate a response to (e.g., an inference based on) ingest data. For example, the ingest data may include information regarding programs being executed by components of a data processing system, and the inference model may be trained to identify, based on the ingest data, a security threat to the data processing system and/or actions for managing the security threat. To manage the security threat, the inference may be provided to a downstream process during which operation of the data processing system may be updated in a manner that mitigates an undesired outcome of the security threat.

However, the responses obtained from the (trained) inference models may not be reliable for managing the operation of the data processing systems if information content of the ingest data used during inferencing is inadequate. For example, terms (e.g., words and/or phrases) included in the prompt may be ambiguous and/or may have special meaning (e.g., a term may have different meaning to an operator of the inference models than a meaning based on its dictionary definition). Therefore, to increase a likelihood of generating reliable responses during inferencing, a retrieval-augmented generation process may be implemented to improve information content of the ingest data to the inference models. To do so, the prompt may undergo preprocessing, during which context data may be obtained for terms present in the prompt.

For example, to obtain expected quality (e.g., adequate) ingest data, the prompt may be provided to a data pipeline. The data pipeline may include a retrieval process, during which terms in the prompt are identified, and context data for the identified terms is obtained. For example, the retrieval process may use methods to (i) identify terms present in the prompt that may require context data, (ii) identify portions of context data from a trusted data source based on the identified terms, (iii) rank the identified portions of context data, and/or (iv) select a number of the ranked identified portions of context data for use as the context data.

However, due to limitations of these methods, the context data obtained during the retrieval process may not be appropriate for generating adequate ingest data to the inference models. For example, (i) not all terms present in the prompt that require context data may be identified, (ii) context data may not be obtained for all of the terms present in the prompt (e.g., identified or unidentified), and/or (iii) the context data obtained during the retrieval process may include hidden information associated with terms present in the prompt. For example, the hidden information may be included in a combination of portions of the context data, and the hidden information may include descriptive information for a term without direct mention of the term.

Consequently, the context data may not be sufficient for generating adequate ingest data. For example, the context data may not be sufficient for providing context for all important terms present in the prompt, and/or the hidden information may include negative information content (e.g., incorrect, outdated, and/or otherwise undesired information) associated with a term. If the ingest data is inadequate, then a subsequent inferencing process that uses the inadequate ingest data may be likely to provide unreliable inferences, and outcomes of downstream processes (e.g., management processes for the data processing systems) that use the inferences may be undesirable.

In general, embodiments disclosed herein may provide methods, systems, and/or devices for managing operation of data processing systems using inference models in a manner that is more likely to result in desirable management outcomes. To do so, prompts for processing by the inference models may be preprocessed through a data pipeline. The data pipeline may include one or more retrieval processes to increase a likelihood of providing sufficient context for all important terms present in the prompt, and verification processes to manage hidden information that may be included in the context data.

The iterative retrieval process may use ontology definitions (e.g., defined by an operator of the inference models) that include a list of ontology terms for which context data is to be retrieved when instances of the ontology terms are present in the prompt. Retrieval processes may be performed to retrieve context data that meets content criteria. For example, the content criteria may specify a minimum level of content of the context data with respect to the ontology definitions. The retrieval processes may be performed iteratively until sufficient context data has been retrieved for each instance of an ontology term present in the prompt.

To manage hidden information included in the context data, the verification process may be performed to identify combinations of portions (e.g., chunks) of the context data that may be related to the instances of the ontology terms present in the prompt. The combinations may be processed to identify whether the hidden information includes positive (e.g., desired) or negative (e.g., undesired) information content, and modifications for use of the context data may obtained in accordance with the identified information content. The verification process may be performed after each retrieval process so that hidden information may be identified prior to performing additional retrieval processes. For example, the identification of positive information content may reduce a number of iterations of retrieval processes required to obtain sufficient context data for the prompt.

By doing so, the context data obtained during prompt preprocessing may be more likely to be appropriate (e.g., sufficient, including positive information content) for generating adequate ingest data to the inference models, thereby increasing a likelihood of the inferences being reliable for use in managing the operation of the data processing systems.

To provide the above-mentioned functionality, the distributed system of FIG. 1 may include data sources 100, downstream consumers 102, inference model manager 104, and communication system 106. The distributed system, any components thereof, and/or any other types of devices or components not shown in FIG. 1 may perform all, or a portion of the computer-implemented services independently and/or cooperatively. Each of these components is discussed below.

Data sources 100 may include any type and/or number of data sources. Each of data sources 100 may include hardware and/or software components configured to obtain data, store data, provide data to other entities, and/or to perform any other tasks to facilitate performance of computer-implemented services. Different data sources of data sources 100 may facilitate similar and/or different computer-implemented services. For example, data sources 100 may include training data sources 100A, prompts 100B, knowledge data sources 100C, and/or other sources of data usable to facilitate operation of inference models.

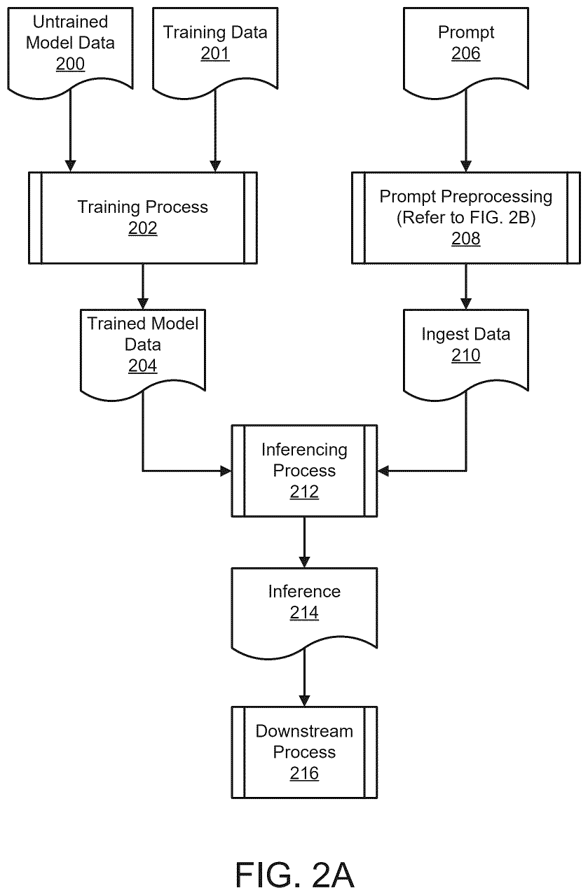

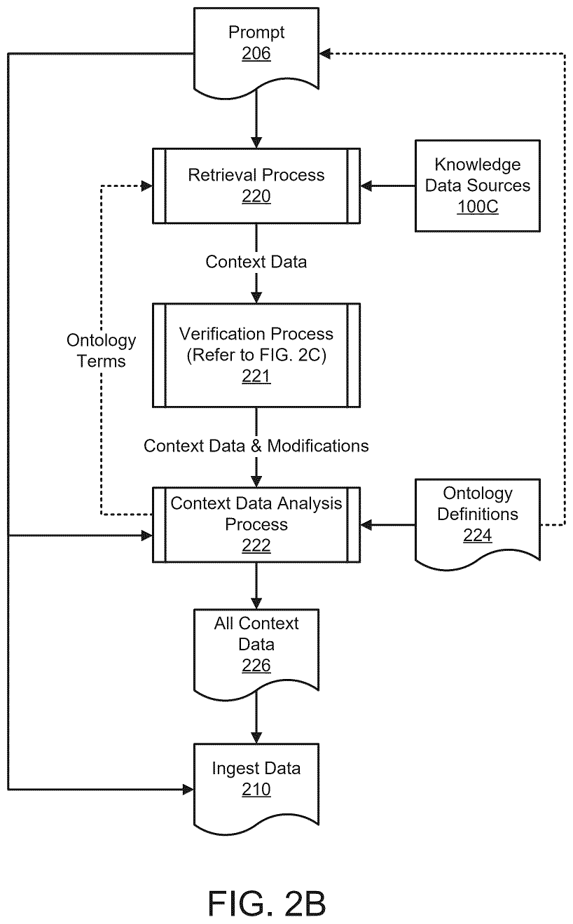

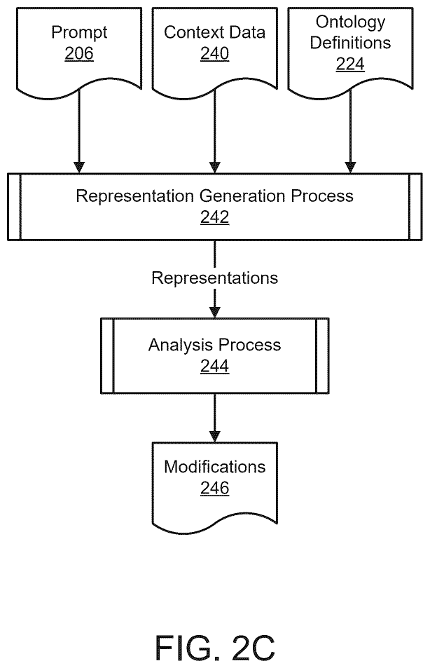

Training data sources 100A may include any number of data sources that provide training data for training of inference models. Training data sources 100A may include sources of raw data, processed data (e.g., curated data), and/or other types of data usable to train (e.g., retrain, fine-tune) the inference models. Refer to the discussion of FIG. 2A for more information regarding training of inference models.

Prompts 100B may include any volume and/or type of data for processing by the inference models. For example, prompts 100B may include any number of prompts obtained from consumers of inferences generated by the inference models (e.g., individuals, computers). Prompts 100B may include unstructured data and may be used, at least in part, to generate ingest data for inference models. For example, prompts 100B may include instances of ontology terms, and may undergo preprocessing to obtain appropriate context data for generating adequate ingest data. Refer to the discussion of FIGS. 2A-2C for more information regarding prompt preprocessing.

Knowledge data sources 100C may include any number and/or type of data sources that provide context data for prompts 100B. Knowledge data sources 100C may include a data source designated as a source of true data by an operator of inference models. Knowledge data sources 100C may be managed by the operator and/or another entity. For example, knowledge data sources 100C may include information regarding ontology terms included in ontology definitions defined by the operator and/or an organization of the operator, and may be queried during preprocessing of a prompt of prompts 100B (e.g., during a retrieval process). Refer to the discussion of FIG. 2B for more information regarding use of knowledge data sources 100C.

Data sources 100 may include data repositories (e.g., training data repositories and/or knowledge data repositories, not shown), and may provide data to (e.g., allow access to data by) inference model manager 104.

Downstream consumers 102 may include any number and/or type of downstream consumers. For example, downstream consumers 102 may include individuals, organizations, and/or computers. Downstream consumers 102 may consume all, or a portion of the computer-implemented services. For example, downstream consumers 102 may include users of the managed data processing systems.

Downstream consumers 102 may consume all, or a portion of the inferences and/or output from downstream processes that use the inferences. For example, downstream consumers 102 may generate and/or provide prompts of prompts 100B (e.g., portions of ingest data) for processing by the inference models, and may consume inferences generated by the inference models (e.g., in response to the ingest data) and/or output from the downstream processes that use the inferences. The inferences and/or output from the downstream processes may be used by downstream consumers 102 to improve decision-making and/or to automate tasks. For example, downstream consumers 102 may make decisions and/or initiate actions for managing operation of the data processing systems.

Inference model manager 104 may include any number of data processing systems and may manage any number of inference models. Inference model manager 104 may perform tasks relating to management of and/or facilitation of use of the inference models. For example, inference model manager 104 may manage (e.g., facilitate) (i) training processes for the inference models, (ii) preprocessing of prompts for the inference models, (iii) inferencing processes using the inference models (e.g., and the preprocessed prompts), (iv) downstream processes that use inferences obtained using the inference models, and/or (v) distribution of the inferences and/or output derived from the inferences to downstream consumers 102. Refer to the discussion of FIG. 2A for more details regarding operation of inference models.

To increase a likelihood of providing adequate ingest data to the inference models, inference model manager 104 may (i) obtain a prompt for an inference model (e.g., from prompts 100B), (ii) perform a retrieval process for the prompt to obtain (chunks of) context data, (iii) perform verification processes to obtain modifications for use of the context data, (iv) analyze the context data using the modifications to identify whether the context data meets sufficiency criteria, and/or (v) obtain ingest data based on the prompt, the context data and the modifications.

The retrieval process may include an iterative retrieval process. For example, to perform the iterative retrieval process, inference model manager 104 may (i) perform a verification process to verify (e.g., analyze hidden information content of the) first context data retrieved during a first retrieval process in order to obtain the modifications for use of the first context data, (ii) analyze the first context data using the modifications to identify instances of ontology terms (specified by ontology definitions) present in the prompt for which the context data does not meet sufficiency criteria, and/or (iii) perform a second retrieval process for the identified instances of ontology terms to retrieve second context data that meets the sufficiency criteria. Portions of context data obtained during each and/or any of the retrieval processes, and modifications obtained during each and/or any of the verification processes may be packaged as context data usable for generating ingest data to the inference models. Refer to the discussion of FIG. 2B for an example of an ontology-based iterative retrieval process.

To manage hidden information included in the context data, inference model manager 104 may identify combinations of chunks that are related to ontology terms specified by the ontology definitions based on representations of the chunks and representations of the ontology terms. The representations may include multi-dimensional vectors indicating characteristics of terms (e.g., ontology terms, other terms), and therefore similar representations may indicate relationships between hidden information content included in the combinations of the chunks and the ontology terms. The modifications may be obtained based on the relationships in order to manage use of the hidden information by inference models. Refer to the discussion of FIG. 2C for an example of obtaining modifications for use of context data.

To facilitate management of operation of the data processing systems using inference models, inference model manager 104 may (i) use the ingest data to obtain a response (e.g., an inference) from an inference model, and/or (ii) use the response to provision desired computer-implemented services (e.g., distribute the response to downstream consumers 102 and/or by provide the response to downstream processes).

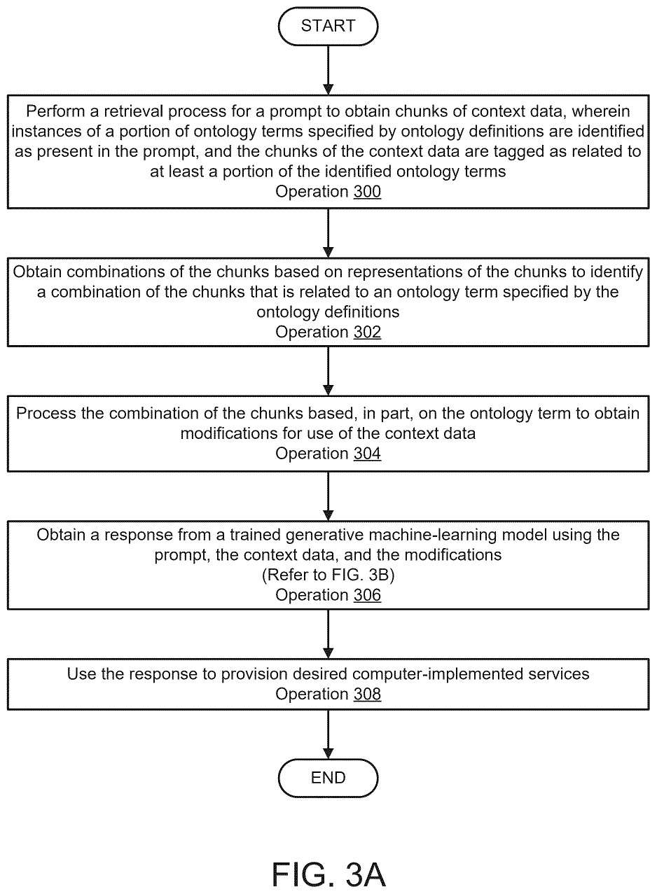

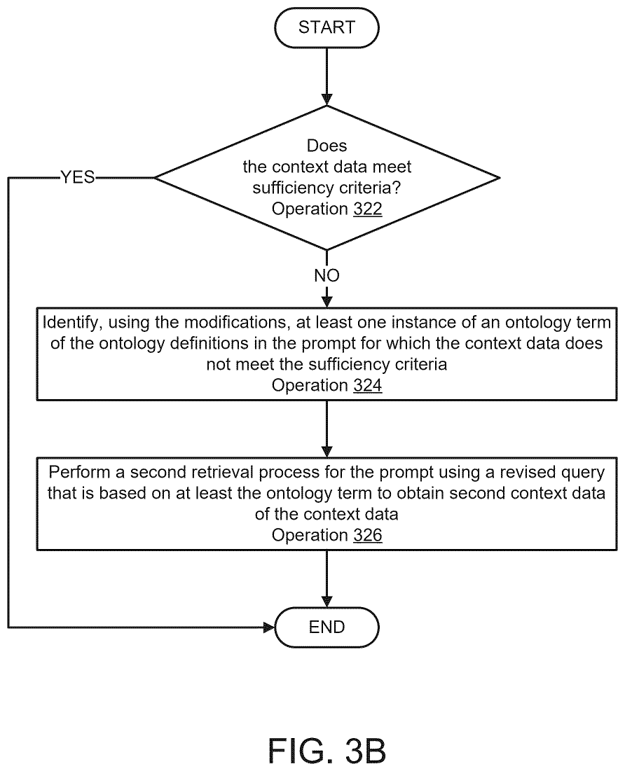

When providing their functionality, any of data sources 100, downstream consumers 102, inference model manager 104, and/or components thereof may perform all, or a portion of the actions and methods illustrated in FIGS. 2A-3B.

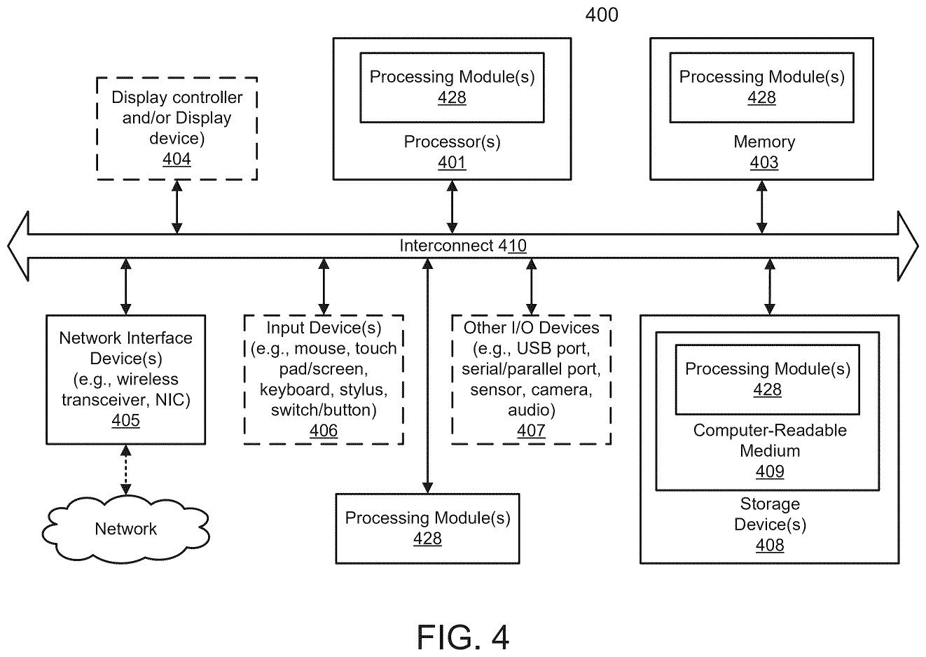

Any of data sources 100, downstream consumers 102, and inference model manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C. In the diagram, flows of data and processing of data are illustrated using different sets of shapes. A first set of shapes (e.g., 200, 201) is used to represent data structures, a second set of shapes (e.g., 202, 212) is used to represent processes performed using and/or that generate data, and a third set of shapes (e.g., 100C) is used to represent sources of data.

Turning to FIG. 2A, a first data flow diagram in accordance with an embodiment is shown. The first data flow diagram may illustrate data used in and data processing performed when facilitating operation of an inference model. For example, the inference model may be used to manage operation of a data processing system.

In the example shown in FIG. 2A, operation of the inference model may include a training process and an inferencing process. The training process may include, for example, initial training of an (untrained) inference model, retraining of an inference model, and/or fine-tuning of an inference model. The inferencing process may include, for example, obtaining inferences using a trained inference model.

To obtain a trained inference model, a management entity (e.g., inference model manager 104) may facilitate performance of training process 202. Training process 202 may include training an untrained inference model defined by untrained model data 200.

Untrained model data 200 may include information relating to model architecture, hyperparameters, and/or other information regarding an untrained inference model (e.g., optimization algorithm information, hidden layer information, bias function descriptions, activation function descriptions, etc.). An inference model type and/or size may be selected based on performance goals and/or constraints, training data availability and/or quality, budget, timeline, etc. For example, the inference model may include a probabilistic model such as a generative machine-learning model (e.g., a large language model).

During training process 202, untrained model data 200 may be updated using training data 201. Training data 201 may be obtained from any number of data sources (e.g., training data sources 100A). For example, if the inference model is being trained to manage security for a data processing system, then the training data may include a corpus of information regarding types of security threats to the data processing system, labeled with actions for responding to the types of security threats (e.g., actions for reconfiguring security settings of the data processing system accordingly). As the inference model is exposed to large numbers of relationships and/or patterns in training data 201, weights and/or other parameters of untrained model data 200 may be modified to obtain trained model data 204.

Trained model data 204 may include inference model data (e.g., information regarding the architecture and/or hyperparameters of the inference model) and/or model parameter values of the inference model (e.g., weights). Trained model data 204 may be used during an inferencing process to generate inferences in response to ingest data, such as ingest data 210.

Ingest data 210 may include a portion of data for which an inference is desired to be obtained. For example, ingest data 210 may include prompt 206 (e.g., of prompts 100B). Prompt 206 may be obtained, for example, from a consumer of inferences and may include instances of ontology terms. To obtain ingest data 210 (e.g., an enhanced version of prompt 206), prompt 206 may undergo prompt preprocessing 208. For example, during prompt preprocessing 208, context data for ontology terms present in prompt 206 may be obtained, modifications may be obtained for use of the context data, and ingest data 210 may be generated based on prompt 206, the context data, and the modifications. Refer to the discussion of FIG. 2B for more details regarding prompt preprocessing and/or obtaining ingest data 210.

Ingest data 210, along with trained model data 204, may be provided to inferencing process 212. During inferencing process 212, a trained inference model may be obtained based on information (e.g., node information, weight information, connection information, activation functions, attention mechanisms, etc.) included in trained model data 204. Ingest data 210 may not include labeled data and, thus, an association for ingest data 210 may not be known. During inferencing process 212, the trained inference model (e.g., a trained generative machine-learning model) may read ingest data 210 and respond with an output likely to be associated with the input (e.g., the trained inference model may generate an inference).

For example, ingest data 210 may include information regarding malicious code being executed by a component of a data processing system, and inference 214 may include actions for updating security settings of the data processing system that are likely to mitigate an outcome of the execution of the malicious code according to relationships and/or patterns learned by the inference model during training process 202. Inference 214 may be used to provision computer-implemented services. For example, inference 214 may be provided to downstream process 216, and downstream process 216 may include delivery of inference 214 to a downstream consumer (e.g., as a computer-implemented service), and/or further processing of inference 214.

For example, downstream process 216 may include any type of process for updating operation of the data processing system based on inference 214. For example, downstream process 216 may include a policy enforcement process, wherein security policies for the data processing system are enforced based on information included in inference 214 (e.g., actions, security and/or configuration settings) in order to mitigate outcomes associated with the execution of the malicious code. For example, operation of the data processing system may be updated to prevent access to sensitive data, to prevent network communication via components of the data processing system, and/or to disable operation of portions of components of the data processing system.

Although described with respect to security of the data processing system, it will be appreciated that the inference models may be trained and used to update operation of the data processing system in various capacities without departing from the embodiments disclosed herein. For example, the operation of the data processing system may be updated to improve user experience, to manage failures of components of the data processing system, to improve efficient allocation of resources (e.g., computing and/or power resources), and/or to meet other operational goals for the data processing system.

Thus, using the data flows shown in FIG. 2A, operation of a data processing system may be managed based on inferences generated by trained inference models. By doing so, operation of the data processing systems may be updated timely, and the data processing systems may be more likely to operate in a desired manner.

However, a quality (e.g., usability, reliability) of the inferences generated by the trained inference models may depend on a quality of ingest data to the trained inference models. Therefore, to increase a likelihood of the ingest data being of expected quality (e.g., having adequate information content), ontology terms included in prompts for the trained inference models may be contextualized. Methods for obtaining context data for the prompts may be discussed with respect to FIG. 2B.

Turning to FIG. 2B, a second data flow diagram in accordance with an embodiment is shown. The second data flow diagram may illustrate data used in and data processing performed when obtaining ingest data for an inference model. FIG. 2B may be an example of prompt preprocessing 208 of FIG. 2A.

To obtain the ingest data, context data for prompt 206 may be retrieved from knowledge data sources 100C. Prompt 206 may include a submission to be processed by a trained inference model to facilitate provisioning of desired computer-implemented services by a data processing system. For example, prompt 206 may include information regarding operation of the data processing system. Instances of a portion of ontology terms specified by ontology definitions may be present in prompt 206.

To obtain the context data for prompt 206, retrieval process 220 may be performed. Retrieval process 220 may include any type of process(es) wherein information (e.g., terms) present in a prompt is identified, and additional information is retrieved from a data source based on the identified information. For example, retrieval process 220 may implement information retrieval methods used during any type of retrieval-augmented generation process.

During retrieval process 220, a prompt (e.g., prompt 206) may be obtained and used to generate a query (e.g., a keyword search query). The query may include, for example, search terms, search parameters, and/or other information. The query may then be used to search an external data source such as knowledge data sources 100C to identify responsive portions of data (e.g., chunks of context data) stored by the external data source.

As discussed with respect to FIG. 1, knowledge data sources 100C may include a data source designated as a source of true (e.g., trusted, reliable, relevant to a subject area) data by an operator of the inference model. For example, knowledge data sources 100C may include a number of chunks of data that are tagged to associate each of the number of chunks of data with ontology terms (and/or other searchable terms). In other words, the chunks of data may be tagged as related to the ontology terms based on relationships between information content of the chunks and the ontology terms. For example, a chunk of data that includes an instance of an ontology term and/or a derivative term of the ontology term may be tagged as related to the ontology term.

During a first performance of retrieval process 220, an original query may be generated based on prompt 206 (e.g., during the first performance of retrieval process 220, ontology terms may not be obtained from context data analysis process 222 as indicated by a respective arrow drawn in dashing). In some examples, the original query may be generated using ontology definitions 224, as indicated by the arrow drawn in dashing. Ontology definitions 224 may include, for example, a list (e.g., a table) of ontology terms. As discussed with respect to FIG. 1, the ontology terms may include words and/or phrases that have been designated as having a higher degree of meaning by an operator of the inference model than other words and/or phrases not designated as having the higher degree of meaning by the operator. For example, the ontology terms may include words and/or phrases that have different definitions in different subject areas.

The original query may be derived from terms (e.g., words and/or phrases) present in prompt 206 and/or ontology terms specified by ontology definitions 224 (e.g., instances of which are present in prompt 206). For example, prompt 206 may be searched to identify instances of the ontology terms present in prompt 206, and the original query may include a list of search terms consisting of the identified ontology terms. The original query may be serviced using a deterministic process (e.g., using a trained deterministic inference model and/or any process that returns the same results for repeated servicing of the original query). For example, using the search parameters and/or instructions included in the original query, portions of data responsive to the search terms of the original query may be identified and obtained from knowledge data sources 100C.

The identified portions of data responsive to the original query may then be ranked for relevance using a relevance ranking algorithm. The relevance ranking algorithm used to rank the portions of data may rely on the portions being appropriately tagged. For example, the portions of data responsive to the search terms may be tagged as related to the search terms. In other words, each chunk of context data retrieved from knowledge data sources 100C may be tagged as related to at least one ontology term. Some number (e.g., best hits) of the ranked chunks of context data may then be selected for use as the context data.

However, due to the limitations of the relevance ranking algorithm and/or selection criteria, the selected context data may lack context for some terms present in the prompt such as those defined by ontology definitions 224. Additionally, if the chunks of the context data are not appropriately tagged, then the relevance ranking algorithm may not select relevant chunks and/or may select irrelevant chunks to be included in the context data.

Knowledge data sources 100C may include, for example, large documents, and the chunks of the context data retrieved from knowledge data sources 100C may include subsets of the large documents. Consequently, the chunks of context data and/or combinations thereof may be likely to include hidden information regarding ontology terms of ontology definitions 224. The hidden information may include negative information content and/or positive information content regarding the ontology terms, and the chunks of the context data may not be appropriately tagged to reflect the hidden information.

Consider an example where knowledge data sources 100C includes a collection of product catalogs for components of data processing systems, and two chunks of context data retrieved from knowledge data sources 100C include subsets of the product catalog, such as information regarding operation of a first component with respect to a second component.

In a first example, the two chunks may be tagged as related to the first component, but not tagged as related to the second component. Therefore, the hidden information may include positive information content regarding the second component, and the two chunks may not be tagged appropriately. As a result, the relevance ranking algorithm may be less likely to select the combination of the chunks to be included in the context data.

In a second example, the two chunks may be tagged as related to both the first and the second component, but the information regarding the operation of the first component may include information for a different version of the first component than is specified by ontology definitions 224, and the different version of the first component may operate differently with respect to the second component than the version of the first component specified by ontology definitions 224. Therefore, the two chunks may include negative information content (e.g., incorrect, irrelevant, outdated) regarding the first component. The negative information content may negatively impact a quality of the context data, and therefore a quality of management processes for the data processing systems that use the context data.

Therefore, to address these limitations of retrieval process 220, verification process 221 and context data analysis process 222 may be performed. For example, to increase a likelihood that context data obtained during retrieval process 220 is appropriately tagged (and to otherwise manage hidden information included in the context data), verification process 221 may be performed. During verification process 221, the chunks of the context data may be analyzed to identify combinations of the chunks that include hidden information regarding ontology terms specified by ontology definitions 224. The identified combinations of the chunks may be processed to obtain modifications for use of the context data (e.g., the combinations of the chunks).

The modifications may include information usable by context data analysis process 222 and/or other processes to mitigate impacts of hidden information on the generation of context data for inferencing processes used to manage the data processing systems. For example, the modifications may include portions of context data from retrieval process 220, modified portions of context data from retrieval process 220, and/or additional instructions regarding use of the context data from retrieval process 220. Refer to the discussion of FIG. 2C for more details regarding obtaining modifications for use of context data.

To increase a likelihood that sufficient context data is obtained during retrieval process 220, context data analysis process 222 may be performed. During context data analysis process 222, context data and any modifications obtained from verification process 221 for use of the context data may be analyzed using ontology definitions 224.

For example, first context data obtained from a first retrieval process (e.g., a first iteration of retrieval process 220) and first modifications for the first context data obtained from a first verification process (e.g., a first iteration of verification process 221) may be evaluated to determine whether the first context data meets sufficiency criteria in view of the modifications. The sufficiency criteria may specify a minimum level of content of context data with respect to ontology definitions 224.

For example, instances of ontology terms specified by ontology definitions 224 that are present in prompt 206 may be identified, and levels of content associated with each identified ontology term may be obtained. For example, all chunks of the first context data tagged as related to an ontology term (e.g., a portion of the tags may be indicated by the first modifications) may be grouped, and a level of content for the group may be obtained. The levels of content may be compared to the minimum level of content to identify any identified ontology terms for which the first context data (and the first modifications) does not meet the sufficiency criteria.

For example, the minimum level of content may specify, for each ontology term of ontology definitions 224 present in prompt 206, (i) a minimum number of words related to the respective ontology terms, (ii) a minimum number of chunks of data in the first context data that are tagged as related to the respective ontology terms, and/or (iii) a combination thereof.

The sufficiency criteria for the context data may be defined by policies. For example, the policies may specify a reduced number of ontology terms present in prompt 206 that are required to satisfy the minimum level of content, and/or an increased number of terms (e.g., other ontology terms defined by ontology definitions 224, other terms not defined by ontology definitions 224) beyond the ontology terms present in prompt 206 that are required to satisfy the minimum level of content. Any instances of ontology terms identified as present in prompt 206 that are not associated with context data satisfying at least the minimum level of content may be identified during context data analysis process 222.

If the first context data meets the sufficiency criteria for all ontology terms present in prompt 206, then the first context data may be included in all context data 226. However, if at least one instance of an ontology term may be identified for which the first context data does not meet the sufficiency criteria, then at least a portion of the first context data may be included in all context data 226 (e.g., the portion of the first context data that meet the sufficiency criteria).

In a first example, the at least one instance of the ontology term (e.g., shown as “ontology terms” in FIG. 2B) having insufficient context data may be provided to retrieval process 220 to initiate a second (iteration of) retrieval process 220 (e.g., ontology terms for which sufficient context data has been retrieved may not be included in the ontology terms provided to retrieval process 220.

In a second example, the ontology terms provided to retrieval process 220 may include all ontology terms identified in prompt 206, and each of the ontology terms may be tagged (e.g., via updating metadata) to indicate whether sufficient context data has been retrieved for each of the ontology terms. For example, the ontology term associated with the identified at least one instance may be tagged as being associated with insufficient context data, while other ontology terms may be tagged as being associated with sufficient context data.

Note that the arrow indicating the ontology terms are provided to retrieval process 220 is drawn in dashing to indicate that under some conditions the ontology terms may not be provided to retrieval process 220 (e.g., during a first iteration of retrieval process 220 and/or during subsequent iterations of retrieval process 220 when retrieved context data meets the sufficiency criteria for all ontology terms present in prompt 206).

During the second retrieval process, a revised query may be derived using the ontology terms obtained from context data analysis process 222. For example, the revised query may only include ontology terms that are tagged as associated with insufficient context data. The revised query may include a reduced number of ontology terms specified by the ontology definitions when compared to a number of ontology terms specified by the original query. The reduced number of ontology terms may include the ontology term (e.g., for which the at least one instance of the ontology term was identified), and may exclude a second ontology term of ontology definitions 224 for which an instance of the second ontology term is present in prompt 206 and for which the first context data meets the sufficiency criteria (e.g., the second ontology term having been included in the original query).

Consider a security example where a prompt, “Program A is being executed by component C of data processing system D, using resources Q, and is accessing file F”, is provided to retrieval process 220. During the first retrieval process, “A”, “C”, “D”, and “F” may include ontology terms specified by ontology definitions 224. The ontology terms may be identified and used to obtain the original query. Therefore, the original query may include four ontology terms specified by ontology definitions 224.

During the first retrieval process, knowledge data sources 100C may return sufficient context data for “A” “C”, and “D”, but not “F”. Therefore, during context data analysis process 222, “F” may be identified as not being associated with at least the minimum level of content specified by the sufficiency criteria. Therefore, context data analysis process 222 may provide a data package including “F” (and excluding “A”, “C”, and “D”, for which sufficient context data has already been obtained) to retrieval process 220, and a second retrieval process may be performed. The second retrieval process may use a revised query that includes only one ontology term specified by ontology definitions 224 (e.g., “F”); therefore, the revised query may be more likely (than the original query) to be serviced in a manner that returns context data for “F”.

Returning to the second retrieval process, the revised query may be used to retrieve second context data from knowledge data sources 100C. By using the revised query, the search algorithm used during retrieval process 220 may be more likely to rank and select sufficient context data for the ontology terms included in the revised query compared to when using the original query.

The second context data may be provided to verification process 221 where a second verification process may be performed. During the second verification process, combinations of chunks of the second context data may be analyzed, and any combinations of the chunks with hidden information regarding ontology terms specified by ontology definitions 224 may be processed to obtain second modifications for the second context data.

The second context data and the second modifications may be provided to context data analysis process 222, and a determination may be made regarding whether the second context data meets the sufficiency criteria in view of the second modifications. If the second context data meets the sufficiency criteria, then the second context data may be included in all context data 226. However, if the second context data does not meet the sufficiency criteria, then at least a portion of the second context data may be included in all context data 226, and context data analysis process 222 may be performed to identify ontology terms for which the second context data is insufficient. Iterations of retrieval process 220 and/or context data analysis process 222 may be performed until all context data 226 meets the sufficiency criteria for each instance of ontology terms present in prompt 206.

All context data 226 may include context data retrieved during any number of iterations of retrieval process 220, and modifications obtained during any number of iterations of verification process 221. In other words, all context data 226 may include chunks of context data that are appropriately tagged (e.g., as indicated, in part, by the modifications) as related to the portion of the ontology terms for which instances are identified as present in prompt 206.

All context data 226 may be used, in part, to obtain ingest data 210. For example, ingest data 210 may include all context data 226 (e.g., the first context data, the first modifications, the second context data, and/or the second modifications) and/or prompt 206. Ingest data 210 may be provided to an inferencing process so that a response (e.g., an inference) may be obtained using a trained inference model. For example, ingest data 210 may be provided to inferencing process 212 of FIG. 2A.

Returning to the security example, the response obtained from the inference model (e.g., inference 214 in FIG. 2A) during the inferencing process may indicate that program A is likely to include malicious code, and that file F is not expected to be accessed by program A during desired operation of data processing system D. The response may indicate that a security policy for data processing system D should be enforced (e.g., which may occur during downstream process 216 of FIG. 2A).

Thus, using the data flows shown in FIG. 2B, a quality of ingest data to inference models may be improved using context data obtained via an iterative retrieval process. The iterative retrieval process may be more likely to produce sufficient context data for instances of ontology terms present in prompts submitted for processing by the inference models. The retrieval processes may be paired with verification processes to manage hidden information included in the context data, thereby increasing a quality of ingest data to the inference models. By doing so, inferences obtained based on the ingest data may be more likely to be reliable for managing operation of data processing systems, and the data processing systems may be more likely provide desired computer-implemented services.

Turning to FIG. 2C, a third data flow diagram in accordance with an embodiment is shown. The third data flow diagram may illustrate data used in and data processing performed when obtaining modifications for use of context data. FIG. 2C may be an example of verification process 221 of FIG. 2B. For example, context data 240 may be obtained from retrieval process 220 and may include contextual information for instances of a portion of ontology terms specified by ontology definitions 224 that are identified as present in prompt 206.

To obtain the modifications, combinations of chunks of context data 240 may be obtained based on representations of the chunks. To obtain the representations of the chunks, representation generation process 242 may be performed. Representation generation process 242 may include an embedding process and/or other processes for generating mathematical representations of objects such as text, images, audio, etc. For example, representation generation process 242 may be performed using a machine-learning model trained to generate representations for ingested objects. The representations may include an array of meaningful data regarding characteristics of the objects.

During representation generation process 242, representations may be obtained for terms included in prompt 206, ontology definitions 224, and/or context data 240. For example, representation generation process 242 may generate representations for all ontology terms specified by ontology definitions 224 and may store the representations in a database (e.g. a vector database, not shown) for future use prior to generating representations for context data 240 and/or prompt 206.

The representations may include embeddings, such as multi-dimensional vectors whose vector entries indicate information regarding different types of characteristics of words and/or phrases. For example, a representation of an ontology term may include an array of numerical values, with each numerical value indicating a measure of a characteristic of the ontology term. The representations may include data usable by a vector searching algorithm to search for similar representations (e.g., within defined thresholds). For example, the representations may be used to identify a combination of chunks of context data 240 that is related to an ontology term specified by ontology definitions 224. To do so, the representations may be provided to analysis process 244.

During analysis process 244, combinations of the representations of the chunks of context data 240 may be obtained. The combinations may include linear combinations of two or more chunks of context data 240. During analysis process 244, the combinations may be analyzed to identify a combination of the chunks that is related to an ontology term. The combinations may be analyzed using a vector searching algorithm and/or using other methods.

For example, a first representation for the combination of the chunks may be obtained, and a second representation of the ontology term may be obtained (e.g., from the vector database). Both the first representation and the second representation may include multi-dimensional vectors, and the first representation may include a linear combination of two or more vectors. The first representation may be compared to the second representation to identify a level of similarity between the first representation and the second representation. For example, a similarity function based on weighted vector elements may be evaluated to identify the level of similarity. If the level of similarity is within a predefined similarity threshold, then the combination of the chunks may be treated as related to the ontology term. In other words, the combination of the chunks may include hidden information regarding the ontology term.

Once the combination of the chunks is identified, the combination of the chunks may be processed. For example, scalar multipliers of the linear combination (e.g., the first representation) may be identified. Negative scalar multipliers may be associated with negative information content regarding the ontology term, and positive scalar multipliers may be associated with positive information content regarding the ontology term. Modifications 246 (e.g., modifications for use of the combination of the chunks) may be obtained based on whether the combination of the chunks includes positive or negative information content.

If the information content is positive, then modifications 246 may indicate that the combination of the chunks is to be treated as tagged as being related to the ontology term during subsequent processes. For example, modifications 246 may include instructions for updating metadata of the combination of the chunks to indicate a relation to the ontology term. By doing so, the combination of the chunks may be appropriately tagged, improving output from subsequent processes.

If the information content is negative, then an indication may be added to modifications 246 to mitigate a negative information content impact on subsequent processes due to the combination of the chunks. For example, modifications 246 may include (i) instructions that indicate that at least a portion of the combination of the chunks (e.g., that includes the negative information content) is not to be processed by a context data analysis process (e.g., 222) and/or during an inferencing process (e.g., 212) by an inference model, and/or (ii) instructions for modifying the combination of the chunks to remove the data portion that includes the negative information content.

Consider an example where context data is retrieved for a current version of a piece of software. The context data for the piece of software may include information regarding features of the software. A first chunk of the context data may include information regarding features that were added to the current version of the piece of software, and a second chunk of the context data may include information regarding features included in all previous versions of the piece of software. Thus, while each of the first chunk and the second chunk may not independently sufficiently (e.g., based on sufficiency criteria) describe all features of the current version of the piece of software, the combination of the first chunk and the second chunk may do so sufficiently.

However, some of the features in the previous versions of the piece of software may have been removed in the current version (e.g., the removed features being negative information content for the current version of the piece of software). Therefore, modifications for use of the combination of the first chunk and the second chunk may include instructions to (i) treat (e.g., by subsequent processes) the combination as tagged as related to the current version of the piece of software, and/or (ii) remove and/or not process (e.g., by subsequent processes) a portion of the second chunk that includes information regarding the removed features.

Thus, using the data flows shown in FIG. 2C, modifications for use of context data may be obtained based on representations of chunks of the context data. The modifications may be used to manage hidden information in the context data, thereby improving a quality of use of the context data. By doing so, a quality of output from processes that rely on the context data (e.g., context data analysis process 222 of FIG. 2B and/or any subsequent processes such as those shown in FIG. 2A) may be improved by using the modifications.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The information content of any of the data structures may be divided across any number of data structures, may be integrated with other types of information, and/or may be stored in any location.

Turning to FIG. 3A, a first flow diagram illustrating a method in accordance with an embodiment is shown. The first flow diagram may illustrate various operations performed while managing operation of a data processing system.

At operation 300, a retrieval process for a prompt may be performed to obtain chunks of context data. Instances of a portion of ontology terms specified by ontology definitions may be identified as present in the prompt, and the chunks of the context data may be tagged as related to at least a portion of the identified ontology terms. The retrieval process may be performed by querying a knowledge database.

Performing the retrieval process may include performing a first retrieval process to obtain first context data of the context data. The first retrieval process may be performed by methods described with respect to retrieval process 220 of FIG. 2B and/or by other methods. For example, the first retrieval process may be performed by (i) obtaining the prompt, (ii) obtaining (e.g., deriving) an original query based on the prompt, (iii) using the original query to search a trusted data source to retrieve data responsive to the original query, and/or (iv) obtaining the first context data based on at least a portion of the data responsive to the original query.

At operation 302, combinations of the chunks of the context data (e.g., the first context data) may be obtained based on representations of the chunks to identify a combination of the chunks that is related to an ontology term specified by the ontology definitions. The combinations of the chunks may be obtained using methods described with respect to FIG. 2C and/or by other methods. For example, the combinations of the chunks may be obtained by (i) receiving the combinations of the chunks (e.g., from another device), (ii) reading the combinations of the chunks (e.g., from storage), and/or (iii) generating the combinations of the chunks. For example, the combinations of the chunks may be generated by providing the chunks of the context data to a neural network trained to obtain representations (e.g., embeddings) of each of the chunks of the context data.

Obtaining the combinations of the chunks may include (i) obtaining a first representation for the combination of the chunks, (ii) comparing the first representation to a second representation of the ontology term to identify a level of similarity between the first representation and the second representation, and/or (iii) treating the combination of the chunks as related to the ontology term based on the level of similarity and a similarity threshold.

The first representation may be obtained by (i) receiving the first representation (e.g., from another device), (ii) reading the first representation (e.g. from storage), and/or (iii) generating the first representation. For example, the first representation may be generated by (i) providing the combination of the chunks to the neural network, and (ii) obtaining output from a hidden layer of the neural network. The second representation may be obtained using similar methods. For example, the second representation may be obtained from a database that manages (e.g., stores) representations of ontology terms specified by the ontology definitions. Refer to representation generation process 242 of FIG. 2C for more details regarding representations.

The first representation may be compared to the second representation by evaluating a function of elements of the representations. For example, the first representation may include a linear combination of two or more multi-dimensional vectors and the second representation may include one multi-dimensional vector. The vectors may include elements (e.g., vector entries) that indicate characteristics of words and/or phrases, such as ontology terms, and comparing the vectors may include comparing a portion of the elements of each of the vectors to identify the level of similarity. For example, the level of similarity may be identified by evaluating a function of vector elements of each representation, and the level of similarity may include a numerical value.

The level of similarity may be compared to a similarity threshold. For example, if the level of similarity is inferior to the similarity threshold (e.g., is within the similarity threshold), then the first representation may be considered similar to or same as the second representation, and the combination of the chunks may be treated as being related to the ontology term. The combination of the chunks may be treated as being related to the ontology term by processing the combination of the chunks (e.g., at operation 304).

If the level of similarity is not inferior to the similarity threshold (e.g., is outside of the similarity threshold), then the combination of the chunks may not be treated as being related to the ontology term. The combination of the chunks may be treated as not being related to the ontology term by not processing the combination of the chunks.

At operation 304, the combination of the chunks may be processed based, in part, on the ontology term to obtain modifications for use of the context data. The combination of the chunks may be processed by methods described with respect to analysis process 244 of FIG. 2C and/or by other methods.

Processing the combination of the chunks may include treating the combination of the chunks as tagged as being related to the ontology term. The combination of the chunks may be treated as tagged as being related to the ontology term by obtaining (e.g., generating) modifications for the combination of the chunks. For example, the modifications may include (i) instructions for updating metadata of the combination of the chunks (e.g., metadata of each chunk of the combination of the chunks) to reflect a relationship to the ontology term, (ii) instructions for tagging the combination of the chunks as related to the ontology term (e.g., updating a knowledge database of context data such as knowledge data sources 100C), and/or (iii) an indication (e.g., a supplemental prompt for an inference model indicating) that the combination of the chunks is related to the ontology term.

Processing the combination of the chunks may include adding an indication to the modifications to mitigate a negative information content impact on the response due to the combination of the chunks. The indication may be added to the modifications by (i) obtaining and adding instructions for processing by an inference model indicating the combination of the chunks is not to be processed, and/or (ii) flagging the combination of the chunks as not to be processed by the inference model.

At operation 306, a response may be obtained from a trained generative machine-learning model (e.g., an inference model) using the prompt, the context data, and the modifications. The response may be obtained by (i) receiving the response (e.g., from another device), (ii) reading the response (e.g., from storage), and/or (iii) generating the response. The response may be generated using methods described with respect to FIG. 2A and/or by other methods. For example, the response may be obtained by (i) obtaining (e.g., training) the trained generative machine-learning model, (ii) obtaining (e.g., generating) ingest data for the trained generative machine-learning model, and/or (iii) providing the ingest data to the trained generative machine-learning model for processing. The response may be obtained by performing all or a portion of operations shown in FIG. 3B.

Turning to FIG. 3B, a second flow diagram illustrating a method in accordance with an embodiment is shown. The second flow diagram may be an expansion of operation 306 of FIG. 3A and may illustrate various operations performed while using the modifications to obtain the response from the trained generative machine-learning model.

At operation 322, a determination regarding whether the context data (e.g., the fist context data obtained at operation 300) meets sufficiency criteria may be made using the modifications. The determination may be made by methods described with respect to context data analysis process 222 and/or by other methods (e.g., obtaining a notification indicating whether the first context data meets the sufficiency criteria). The sufficiency criteria may specify a minimum level of content of the first context data with respect to the portion of the ontology terms (e.g., the portion of the ontology that the context data is tagged as related to). In other words, different portions of the context data may be associated with different ontology terms specified by the ontology definitions.

For example, the determination may be made by (i) identifying portions of the context data associated with each ontology term for which an instance is present in the prompt, including associations to the combinations of the chunks as indicated by the modifications, (ii) obtaining characteristics for each of the portions of the context data (e.g., a number of words in each of the portions, a number of data chunks in each of the portions), and/or (iii) comparing the characteristics for each of the portions to a minimum level of content (e.g., a minimum number of words, a minimum number of data chunks). If the characteristics of one or more of the portions do not meet the minimum level of content (e.g., if the number of words in a portion is inferior to the minimum number of words), then the context data may not meet the sufficiency criteria. Otherwise, if the characteristics of all of the portions meet the minimum level of content, then the context data may meet the sufficiency criteria.

In a first instance of the determination where the context data does not meet the sufficiency criteria with respect to the ontology definitions, the method may proceed to operation 324 following operation 322. Otherwise, in a second instance of the determination where the context data meets the sufficiency criteria, the method may end following operation 322.

At operation 324, at least one instance of an ontology term of the ontology definitions in the prompt for which the context data does not meet the sufficiency criteria may be identified using the modifications. The at least one instance of the ontology term may be identified by methods described with respect to context data analysis process 222 and/or by other methods. For example, the at least one instance of the ontology term may be identified by (i) obtaining a notification indicating that the context data does not meet the sufficiency criteria for the at least one instance of the ontology term, (ii) identifying a portion of the context data that does not meet the sufficiency criteria (e.g., from operation 322), and/or (iii) identifying an ontology term associated with the identified portion. For example, if the identified portion of the context data includes the combination of the chunks, then the modifications may be used to identify the ontology term associated with the combination of the chunks.

At operation 326, a second retrieval process for the prompt may be performed using a revised query that is based on at least the ontology term to obtain second context data. The second retrieval process may be performed by methods described with respect to FIG. 2A, operation 300, and/or by other methods. For example, the second retrieval process may be performed by (i) obtaining the ontology term, (ii) obtaining (e.g., deriving) a revised query based on the ontology term, (iii) using the revised query to search the trusted data source to retrieve data responsive to the revised query, and/or (iv) obtaining second context data based on at least a portion of the data responsive to the revised query.

As discussed with respect to FIG. 2B, subsequent retrieval processes (third, fourth, etc.), verification processes, and context data analysis processes may be performed until context data obtained during the subsequent retrieval processes meets the sufficiency criteria with respect to the ontology definitions. Once all of the retrieved context data meets the sufficiency criteria, the context data may be used to obtain ingest data for the trained generative machine-learning model.

For example, in the first instance of the determination at operation 322 where the context data meets the sufficiency criteria, the ingest data may be obtained by generating a data package that includes the prompt and the context data; or, in the second instance of the determination at operation 322 where the context data does not meet the sufficiency criteria, additional (e.g., second) context data may be retrieved during subsequent retrieval processes and the ingest data may be obtained by generating a data package that includes the prompt, and a combination of the context data and the additional context data. As described with respect to operation 306 of FIG. 3A, the response may be obtained from the trained generative machine-learning model using the generated ingest data.

The method may end following operation 326.

Returning to FIG. 3A, at operation 308, the response may be used to provision desired computer-implemented services. The response may be used by (i) providing the response to a downstream consumer as a first portion of the desired computer-implemented services, (ii) providing the response to a downstream process to obtain an output from the downstream process, and/or (iii) using the output from the downstream process to provision a second portion of the desired computer-implemented services.

Using the response may include updating the operation of the data processing system. For example, the response may include information regarding policies that should be enforced in order to increase a likelihood of providing the desired computer-implemented services in view of information included in the prompt, the first context data, and/or the second context data. Refer to the discussion of FIGS. 2A-2B for more details regarding use of the response and/or updating the data processing system.

The method may end following operation 308.

Thus, as illustrated above, embodiments disclosed herein may provide systems and methods for managing context data retrieval via verification of the retrieved context data prior to using the context data to generate ingest data for inference models. By managing hidden information included in the context data through verification processes and by increasing a likelihood of retrieving sufficient context data, the resulting ingest data may be more likely to facilitate reliable inferencing by the inference models. As a result, data processing systems managed using the inference models may be more likely to be updated reliably (e.g., appropriately, timely), and the computer-implemented services provided by the data processing systems may be more likely to be desired computer-implemented services.

Any of the components illustrated in FIGS. 1-3B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as Vx Works.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for managing operation of a data processing system, the method comprising:
performing a retrieval process for a prompt to obtain chunks of context data, wherein instances of a portion of ontology terms specified by ontology definitions are identified as present in the prompt, and the chunks of the context data are tagged as related to at least a portion of the identified ontology terms;
obtaining combinations of the chunks based on representations of the chunks to identify a combination of the chunks that is related to an ontology term specified by the ontology definitions;
processing the combination of the chunks based, in part, on the ontology term to obtain modifications for use of the context data by performing scalar multiplication of a first representation of the combination of the chunks and a second representation of the ontology term, wherein the modifications include an instruction to mitigate a negative information content impact on responses due to the combination of the chunks;
obtaining a response from a trained generative machine-learning model using the prompt, the context data, and the modifications, the trained generative machine-learning model ingesting the context data with the instruction of the modifications applied to mitigate negative content impact relative to the context data without the modifications applied; and
using the response to provision desired computer-implemented services.

2. The method of claim 1, wherein the prompt is a submission to be processed by the trained generative machine-learning model to facilitate provisioning of the desired computer-implemented services.

3. The method of claim 1, wherein obtaining the combinations of the chunks comprises:
obtaining the first representation for the combination of the chunks;
comparing the first representation to the second representation of the ontology term to identify a level of similarity between the first representation and the second representation; and
treating the combination of the chunks as related to the ontology term based on the level of similarity and a similarity threshold.

4. The method of claim 3, wherein the first representation and the second representation comprise multi-dimensional vectors indicating characteristics of words and/or phrases.

5. The method of claim 1, wherein processing the combination of the chunks comprises:
treating the combination of the chunks as tagged as being related to the ontology term.

6. (canceled)

7. The method of claim 1, wherein performing the retrieval process comprises:
performing a first retrieval process for the prompt to obtain first context data of the context data.

8. The method of claim 7, wherein obtaining the response comprises:
making, using the modifications, a determination regarding whether the context data meets sufficiency criteria, the sufficiency criteria specifying a minimum level of content of the context data with respect to the portion of the ontology terms; and
in a first instance of the determination where the context data does not meet the sufficiency criteria:
identifying, using the modifications, at least one instance of an ontology term of the ontology definitions in the prompt for which the context data does not meet the sufficiency criteria, and
performing a second retrieval process for the prompt using a revised query that is based on at least the ontology term to obtain second context data of the context data.

9. The method of claim 1, wherein the ontology definitions comprises a list of ontology terms comprising the identified ontology terms, and the ontology terms specified by the ontology definitions are words and/or phrases that have been designated as having a higher degree of meaning by an operator of the trained generative machine-learning model than other words and/or phrases not designated as having the higher degree of meaning by the operator.

10. The method of claim 9, wherein the context data is obtained from a data source designated as a source of true data by the operator of the trained generative machine-learning model, and the data source comprising a number of chunks of data that are each tagged to associate each of the number of chunks of data with the ontology terms.

11. The method of claim 1, wherein using the response to provision the desired computer-implemented services comprises:
updating the operation of the data processing system.

12. A non-transitory machine-readable medium having instructions stored therein, which when executed by a processor, cause the processor to perform operations for managing operation of a data processing system, the operations comprising:
performing a retrieval process for a prompt to obtain chunks of context data, wherein instances of a portion of ontology terms specified by ontology definitions are identified as present in the prompt, and the chunks of the context data are tagged as related to at least a portion of the identified ontology terms;
obtaining combinations of the chunks based on representations of the chunks to identify a combination of the chunks that is related to an ontology term specified by the ontology definitions;
processing the combination of the chunks based, in part, on the ontology term to obtain modifications for use of the context data by performing scalar multiplication of a first representation of the combination of the chunks and a second representation of the ontology term, wherein the modifications include an instruction to mitigate a negative information content impact on responses due to the combination of the chunks;
obtaining a response from a trained generative machine-learning model using the prompt, the context data, and the modifications, the trained generative machine-learning model ingesting the context data with the instruction of the modifications applied to mitigate negative content impact relative to the context data without the modifications applied; and
using the response to provision desired computer-implemented services.

13. The non-transitory machine-readable medium of claim 12, wherein the prompt is a submission to be processed by the trained generative machine-learning model to facilitate provisioning of the desired computer-implemented services.

14. The non-transitory machine-readable medium of claim 12, wherein obtaining the combinations of the chunks comprises:
obtaining the first representation for the combination of the chunks;
comparing the first representation to the second representation of the ontology term to identify a level of similarity between the first representation and the second representation; and
treating the combination of the chunks as related to the ontology term based on the level of similarity and a similarity threshold.

15. The non-transitory machine-readable medium of claim 14, wherein the first representation and the second representation comprise multi-dimensional vectors indicating characteristics of words and/or phrases.

16. The non-transitory machine-readable medium of claim 12, wherein processing the combination of the chunks comprises:
treating the combination of the chunks as tagged as being related to the ontology term.

17. A system, comprising:
a processor; and
a memory coupled to the processor to store instructions, which when executed by the processor, cause operations for managing operation of a data processing system to be performed, the operations comprising:
performing a retrieval process for a prompt to obtain chunks of context data, wherein instances of a portion of ontology terms specified by ontology definitions are identified as present in the prompt, and the chunks of the context data are tagged as related to at least a portion of the identified ontology terms,
obtaining combinations of the chunks based on representations of the chunks to identify a combination of the chunks that is related to an ontology term specified by the ontology definitions,
processing the combination of the chunks based, in part, on the ontology term to obtain modifications for use of the context data by performing scalar multiplication of a first representation of the combination of the chunks and a second representation of the ontology term, wherein the modifications include an instruction to mitigate a negative information content impact on responses due to the combination of the chunks,
obtaining a response from a trained generative machine-learning model using the prompt, the context data, and the modifications, the trained generative machine-learning model ingesting the context data with the instruction of the modifications applied to mitigate negative content impact relative to the context data without the modifications applied, and
using the response to provision desired computer-implemented services.

18. The system of claim 17, wherein the prompt is a submission to be processed by the trained generative machine-learning model to facilitate provisioning of the desired computer-implemented services.

19. The system of claim 17, wherein obtaining the combinations of the chunks comprises:
obtaining the first representation for the combination of the chunks;
comparing the first representation to the second representation of the ontology term to identify a level of similarity between the first representation and the second representation; and
treating the combination of the chunks as related to the ontology term based on the level of similarity and a similarity threshold.

20. The system of claim 19, wherein the first representation and the second representation comprise multi-dimensional vectors indicating characteristics of words and/or phrases.

21. The method of claim 1, wherein the instruction indicates that at least a portion of the combination of the chunks that corresponds to a negative scalar product is not to be processed.
